(19) United States
(12) Patent Application Publication
(10) Pub. No.: US 2005/0278975 A1
(43) Pub. Date: Dec. 22, 2005

(54) Clothing dryer

(75) Inventor: Won-Tae Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/126,147

(22) Filed: May 11, 2005

(30) Foreign Application Priority Data
Jun. 16, 2004 (KR) 2004-44318
Jun. 16, 2004 (KR) 2004-44319

(51) Int. Cl. F26B 19/00; F26B 7/00

(52) U.S. Cl. 34/604; 34/382

(57) ABSTRACT

A clothing dryer and a method of assembling clothing dryer. The clothing dryer includes: a housing forming an external appearance of the clothing dryer; a drying tub rotatably mounted in the housing; an exhaust pipe discharging air from the drying tub out of the clothing dryer; an opening formed at the rear surface of the housing and configured such that internal components mounted in the housing can be easily accessed from the opening; and a rear cover closing the opening.

### CROSS-REFERENCE TO RELATED APPLICATIONS

This application claims the benefit of Korean Patent Application No. 2004-44318, filed on Jun. 16, 2004 and Korean Patent Application No. 2004-44319, filed on Jun. 16, 2004 in the Korean Intellectual Property Office, the disclosures of which are incorporated herein by reference.

### BACKGROUND OF THE INVENTION

1. Field of the Invention

The present invention relates to a clothing dryer, and, more particularly, to a housing structure of the clothing dryer.

2. Description of Related Art

A clothing dryer is a machine that supplies hot air to a drying tub, in which wet clothing is placed, to evaporate moisture contained in the clothing, thereby drying the clothing. A conventional clothing dryer includes: a housing forming an external appearance of the clothing dryer; a drying tub rotatably mounted in the housing; an inlet duct to introduce hot air to the drying tub, an outlet duct to discharge hot air from the drying tub, a blowing fan to generate a blowing force necessary to introduce and discharge hot air; an exhaust pipe to discharge air blown from the blowing fan out of the clothing dryer; and a driving motor to drive the blowing fan and the drying tub.

The housing includes: a base forming the lower surface of the housing; a front panel, side panels, rear panel, and an upper panel. The rear panel is formed integrally with the side panels through a bending process of a metal sheet. When the clothing dryer is assembled, the integrated rear and side panels are attached to the base, and then internal components, such as the drying tub, the inlet duct, the outlet duct, the blowing fan, are mounted on the base. At this time, the internal components are mounted on the base from the front panel before the front panel is attached to the base. For this reason, the components located near the rear part of the clothing dryer or the components not easily accessible from the front of the clothing dryer are not conveniently mounted on the base.

Also, for the same reason, when the components are to be repaired or replaced, it is necessary that the entirety of the clothing dryer be disassembled so as to access the components located near the rear part of the clothing dryer or the components not easily accessible from the front of the clothing dryer.

### BRIEF SUMMARY

It is an aspect of the invention to provide a clothing dryer that allows components not easily accessible from the front of the clothing dryer to be accessed from the rear of the clothing dryer, whereby assembly of the clothing dryer is easily carried out on a production line, and repair and replacement of the components are easily carried out.

According to an aspect of the present invention, there is provided a clothing dryer including: a housing forming an external appearance of the clothing dryer; a drying tub rotatably mounted in the housing; an exhaust pipe discharging air from the drying tub out of the clothing dryer; an opening formed at the rear surface of the housing and configured such that internal components mounted in the housing can be easily accessed from the opening; and a rear cover closing the opening.

The opening may be disposed at the rear end of the exhaust pipe.

The rear cover may include with an exhaust pipe hole that allows the rear end of the exhaust pipe to be inserted therethrough.

The rear cover may have a rim that covers the edge of the opening from the outside of the housing.

The rim of the rear cover may protrude rearward as compared to a central part of the rear cover.

The clothing dryer may further include a fixing member to fix the rear cover to the housing.

According to another embodiment of the present invention, there is provided a clothing dryer including: a housing; an exhaust pipe through which air from a drying tub disposed in the housing is exhaustible to an outside of the clothing dryer; an opening formed at the rear surface of the housing, disposed near the rear end of the exhaust pipe, and configured such that internal components mounted in the housing can be easily accessed through the opening; and a rear cover closing the opening.

According to another embodiment of the present invention, there is provided a method of assembling a clothing dryer, including: mounting internal components in the clothing dryer before a rear cover is attached to the clothing dryer, the rear cover closing an opening formed at the rear surface of a housing; assembling, through the opening formed at a rear surface of the housing, an exhaust pipe, which is not easily accessible from the front of the clothing dryer; and inspecting, through the opening, whether any of the internal components not easily accessible from the front of the clothing dryer have been correctly mounted.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a perspective view showing the external appearance of a clothing dryer according to an embodiment of the present invention;

FIG. 2 is a side view, in section, showing the clothing dryer of FIG. 1;

FIG. 3 is a perspective view showing the inner structure of the clothing dryer of FIG. 1; and

FIG. 4 is a perspective view showing the coupling structure of a rear cover of the clothing dryer of FIG. 1.

### DETAILED DESCRIPTION OF EMBODIMENT

Reference will now be made in detail to an embodiment of the present invention, examples of which are illustrated in the accompanying drawings, wherein like reference numerals refer to like elements throughout. The embodiment is described below to explain the present invention by referring to the figures.

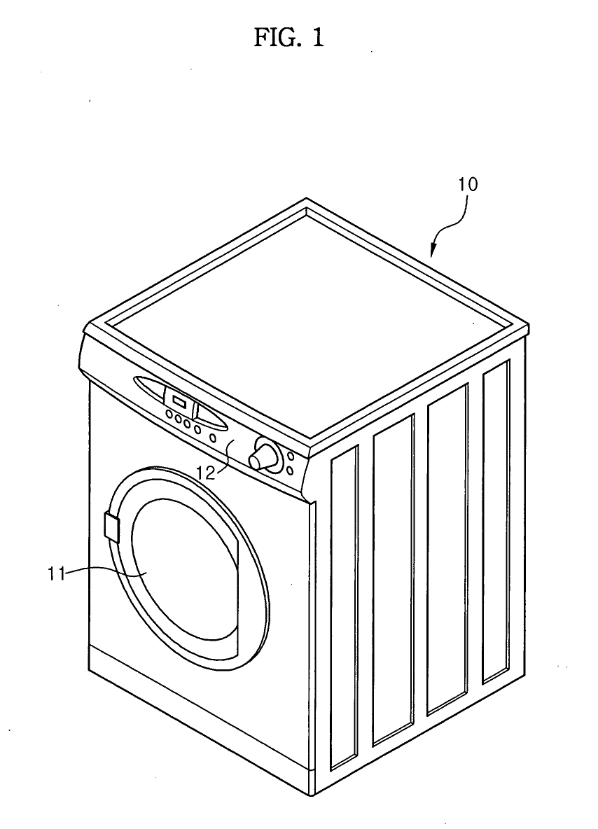

FIG. 1 is a perspective view showing the external appearance of a clothing dryer according to an embodiment of the present invention. As is shown in FIG. 1, the clothing dryer includes a housing 10 forming the external appearance of the clothing dryer. The housing 10 is formed substantially in the shape of a hexahedron. The housing 10 is provided at the front part thereof with a door 11, and at the upper part thereof with a control unit 12 that controls the operation of the clothing dryer.

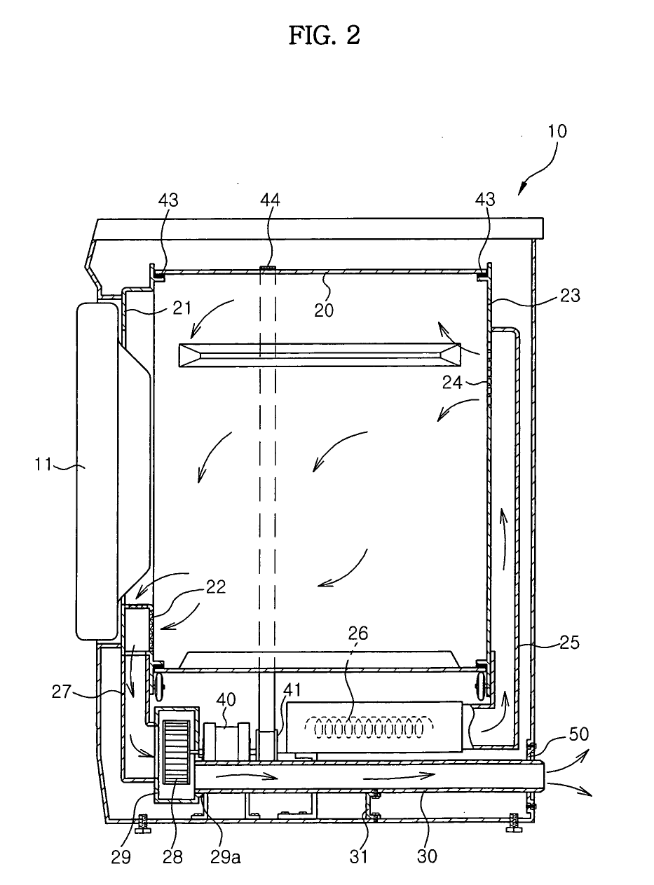

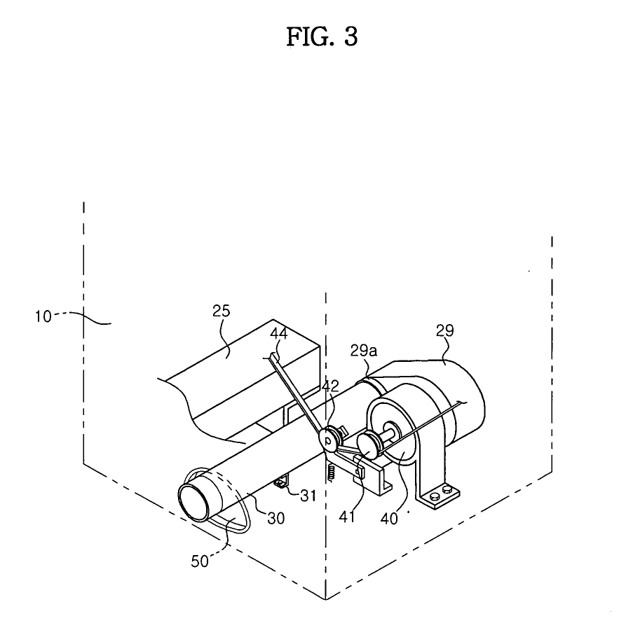

FIG. 2 is a side view, in section, showing the clothing dryer of FIG. 1, and FIG. 3 is a perspective view showing the inner structure of the clothing dryer of FIG. 1. In the housing 10 is mounted a cylindrical drying tub 20, as is shown in FIGS. 2 and 3. The drying tub 20 is supported by respective front and rear brackets 21 and 23, which respectively slidably support the inner circumferences of the front and rear ends of the drying tub 20. Between the drying tub 20 and the front bracket 21 and between the drying tub 20 and the rear bracket 23 are disposed sliding pads 43 to facilitate the rotary movement of the drying tub 20.

At the upper part of the rear bracket 23 is formed an inlet hole 24, through which hot air is introduced into the drying tub 20. At the rear of the rear bracket 23 is disposed an inlet duct 25 that guides hot air to the inlet hole 24. The inlet duct 25 extends rearward from below the drying tub 20, and is then bent upward such that the inlet duct 25 communicates with the inlet hole 24. At the entrance of the inlet duct 25 is disposed a heater 26 that heats air in the housing 10.

At the center of the front bracket 21 is formed an opening, through which clothing to be dried is put into the drying tub 20 from the door 11. At the lower part of the front bracket 21 is formed an outlet hole 22, through which air containing moisture evaporated from the clothing to be dried is discharged out of the drying tub 20.

Below the drying tub 20 are disposed an outlet duct 27, a blowing fan 28, and an exhaust pipe 30, by which air having passed though the outlet hole 22 is discharged out of the clothing dryer. The outlet duct 27 guides the air having passed through the outlet hole 22 to the lower part of the housing 10. The outlet duct 27 is connected to the blowing fan 28 that generates a blowing force necessary to forcibly blow air in the clothing dryer. Air blown by the blowing fan 28 is discharged out of the clothing dryer through the exhaust pipe 30, which has one end connected to the exit of a fan casing 29 of the blowing fan 28 and the other end extending out of the housing 10.

At the lower part of the housing 10 is disposed a driving motor 40 that drives the blowing fan 28 and the drying tub 20 and is capable of simultaneously driving the blowing fan and the drying tub. The driving motor 40 has a driving shaft extending toward the front and rear of the driving motor 40. One end of the driving shaft is connected to the blowing fan 28, and the other end of the driving shaft is connected to a pulley 41 that drives the drying tub 20. The pulley 41 is connected to the drying tub 20 by a belt 44 to rotate the drying tub 20 as the driving motor 40 is operated. Next to the pulley 41 is disposed an idler 42 that maintains constant tension of the belt 44 to ensure smooth movement of the belt 44.

The operation of the clothing dryer with the above-described construction according to the present embodiment will now be described.

When clothing to be dried, for example, wet clothing, is put into the drying tub 20 through the door 11, and then drying operation is carried out by the control unit 12, the driving motor 40 simultaneously rotates the drying tub 20 and the blowing fan 28.

As the drying tub 20 is rotated, the clothing to be dried is jumbled together such that the clothing can be uniformly dried. As the blowing fan 28 is rotated, air in the drying tub 20 is discharged out of the clothing dryer through the outlet duct 27 and the exhaust pipe 30. At this time, air in the housing 10 is supplied, through the inlet duct 25, to the drying tube 20 having lowered pressure created therein due to the discharged air, whereby the pressure in the drying tube 20 is compensated for. The air introduced into the drying tub 20 is heated while passing through the heater 26. Moisture contained in the clothing is evaporated by the hot air, which has been heated by the heater 26. In this way, the clothing is dried.

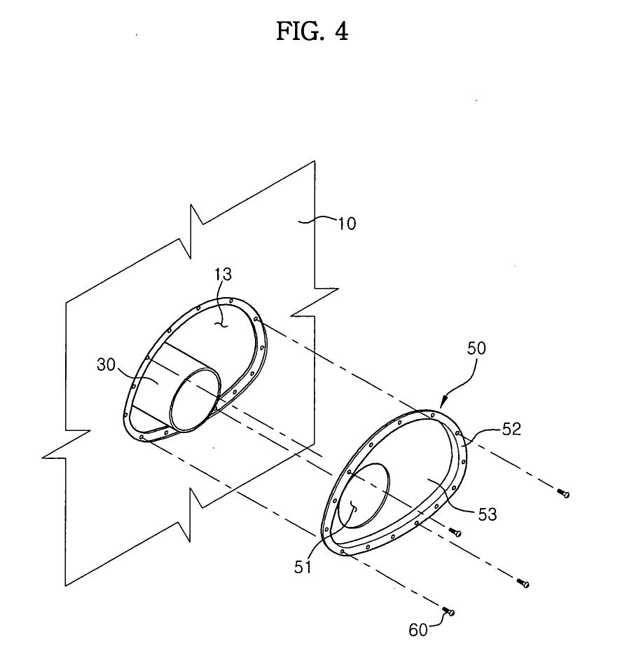

The structure of the housing 10 will be described in more detail. At the lower part of the rear surface of the housing 10 is formed an opening 13 having a predetermined size, as is shown in FIGS. 3 and 4. To the rear surface of the housing 10 is attached a rear cover 50 that closes the opening 13. Specifically, the opening 13 is disposed near the rear end of the exhaust pipe 30, and at the rear cover 50 is formed an exhaust pipe hole 51, through which the exhaust pipe 30 is inserted. At the edge of the exhaust pipe hole 51 is disposed a flange 54, which is bent toward the inside of the housing 10 for supporting the outer circumference of the rear end of the exhaust pipe 30. The flange 54 supports the exhaust pipe 30 over a large area, whereby concentration of an impact is prevented when the impact is applied to the exhaust pipe 30. The rear cover 50 has a rim 52 that covers the edge of the opening 13 from the outside of the housing 10. At the rim 52 of the rear cover 50 are formed a plurality of screw holes. Similarly, another plurality of screw holes are formed at the housing 10 where the rim 52 is attached. Consequently, the rear cover 50 is fixedly attached to the housing 10 by screws 60 fitted though the screw holes formed at the rim 52 of the rear cover 50 and the housing 10. The rim 52 of the rear cover 50 is protruded rearward as compared to a central part 53 of the rear cover 50. This is because the rear cover 50 is contemporaneously fixed to the housing 10 such that the rear cover 50 is not slid from the housing 10 while the central part 53 of the rear cover 50 is fitted in the opening 13, and then the rear cover is easily attached to the housing 10 by the screws 60.

The exhaust pipe 30 is formed in the shape of a cylinder. The exhaust pipe 30 has a front end supportably inserted in a locating part 29a formed at the exit of the fan casing 29 of the blowing fan 28, a middle part supported by a fixing bracket 31 attached to the bottom of the housing 10, and a rear end supported by the rear cover 50 while being inserted through the exhaust pipe hole 51.

When the clothing dryer is assembled, the internal components are mounted in the clothing dryer before the rear cover is attached to the clothing dryer. At this time, the assembling operation of the exhaust pipe 30, which is not easily accessible from the front of the clothing dryer, is carried out through the opening 13 formed at the rear surface of the housing 10. Also, the inspection of whether the internal components not easily accessible from the front of the clothing dryer have been correctly mounted is performed through the opening 13.

When the internal components of the clothing dryer are to be repaired or replaced, they are easily and conveniently repaired or replaced through the opening 13 while the rear cover 50 is removed from the clothing dryer.

The described embodiment of the present invention provides a clothing dryer having an opening formed at the rear surface of a housing such that the internal components can be easily accessed through the opening, and a rear cover that closes the opening, whereby the components not easily accessible from the front of the clothing dryer can be easily and conveniently assembled or disassembled through the opening.

Although an embodiment of the present invention has been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. A clothing dryer comprising:
a housing forming an external appearance of the clothing dryer;
a drying tub rotatably mounted in the housing;
an exhaust pipe discharging air from the drying tub out of the clothing dryer;
an opening formed at the rear surface of the housing and configured such that internal components mounted in the housing can be easily accessed from the opening; and
a rear cover closing the opening.

2. The dryer according to claim 1, wherein the opening is disposed at the rear end of the exhaust pipe.

3. The dryer according to claim 2, wherein the rear cover is includes an exhaust pipe hole which accommodates the rear end of the exhaust pipe.

4. The dryer according to claim 3, wherein the rear cover has a rim that covers the edge of the opening from the outside of the housing.

5. The dryer according to claim 4, wherein the rim of the rear cover protrudes with respect to a central part of the rear cover.

6. The dryer according to claim 5, further comprising a fixing member fixing the rear cover to the housing.

7. The dryer according to claim 3, wherein the exhaust pipe hole includes at the edge of thereof with a flange that supports the exhaust pipe.

8. The dryer according to claim 7, wherein the flange is bent toward the inside of the dryer.

9. A clothing dryer comprising:
a housing;
an exhaust pipe through which air from a drying tub disposed in the housing is exhaustible to an outside of the clothing dryer;
an opening formed at the rear surface of the housing, disposed near the rear end of the exhaust pipe, and configured such that internal components mounted in the housing can be easily accessed through the opening; and
a rear cover closing the opening.

10. The clothing dryer of claim 9, wherein the rear cover includes an exhaust pipe hole which accommodates the exhaust pipe.

11. The clothing dryer of claim 10, wherein the rear cover includes a flange around the exhaust pipe hole.

12. The clothing dryer of claim 11, wherein the flange supports the exhaust pipe over a large area so as to prevent a concentration of an impact applied to the exhaust pipe 30.

13. The clothing dryer of claim 9, wherein the rear cover is fixedly attached to the housing by screws.

14. A method of assembling a clothing dryer, comprising:
mounting internal components in the clothing dryer before a rear cover is attached to the clothing dryer, the rear cover closing an opening formed at the rear surface of a housing;
assembling, through the opening formed at a rear surface of the housing, an exhaust pipe, which is not easily accessible from the front of the clothing dryer; and
inspecting, through the opening, whether any of the internal components not easily accessible from the front of the clothing dryer have been correctly mounted.

15. The method of claim 14, wherein the mounting and assembling are performed at least substantially contemporaneously.
